(19) United States
(12) Patent Application Publication
(10) Pub. No.: US 2026/0180169 A1
(43) Pub. Date: Jun. 25, 2026

(54) ANTENNA SYSTEM FOR ANTENNA STEERING AND METHOD

(71) Applicant: MacDonald, Dettwiler and Associates Corporation, Sainte-Anne-de-Bellevue (CA)

(72) Inventors: Marc-André Godin, Laval (CA); Karim Glâtre, Montreal (CA)

(21) Appl. No.: 18/714,479

(22) PCT Filed: Dec. 13, 2023
(86) PCT No.: PCT/CA2023/051653

§ 371 Date: May 29, 2024

Related U.S. Application Data
(60) Provisional application No. 63/432,236, filed on Dec. 13, 2022.

(51) Int. Cl. H01Q 3/20; H01Q 19/17; H01Q 19/19

(52) U.S. Cl. CPC H01Q 3/20; H01Q 19/17; H01Q 19/19

(57) ABSTRACT

Disclosed herein is an antenna system including a radiating component for transmitting and/or receiving a radio frequency signal, the radiating component longitudinally aligned along a first axis, and a reflector assembly coupled to the radiating component through a gimbal, wherein the gimbal is configured to rotate the reflector assembly about the first axis to steer the antenna system, such that when the reflector assembly is rotated, the location of a focal point of the reflector in space remains unchanged.

### TECHNICAL FIELD

The following relates generally to antennas, and more particularly to systems, methods, and devices for antenna steering for use in space environments.

### INTRODUCTION

Antenna systems may be used to transmit and receive radio frequency (RF) signals. Some antenna designs may transmit or receive RF signals directionally, wherein the antenna must be aligned with a transmitting or receiving terminal or antenna. Some antenna systems may be configured to change the position or direction of the antenna to direct or received RF signals to different receiving or transmitting terminals.

Various designs are currently implemented to steer or position an antenna for signal steering. Current solutions require complicated rotary joints and mechanics, may result in reduced RF performance or an increase in cost, or are otherwise complex.

Accordingly, there is a need for an improved antenna steering apparatus that overcomes at least some of the disadvantages of existing solutions.

### SUMMARY

An antenna system is provided. The system includes a feed chain for transmitting and/or receiving a radio frequency signal and a reflector assembly. The feed chain is longitudinally aligned along a first axis. The reflector assembly is coupled to the feed chain through a gimbal and includes a focal point, wherein the gimbal is configured to rotate the reflector assembly about the first axis to steer the antenna system, such that when the reflector assembly is rotated, the feed chain remains at the focal point of the reflector assembly.

According to some embodiments, the gimbal comprises a bi-axis gimbal, and the bi-axis gimbal is configured to rotate the reflector assembly about the first axis and a second axis, such that when the reflector assembly is rotated, the feed chain remains at the focal point of the reflector assembly.

According to some embodiments, the two axes are orthogonal. In some embodiments, the two axes are not orthogonal.

According to some embodiments, the reflector assembly is coupled to the gimbal through a boom.

According to some embodiments, the gimbal comprises a through-hole actuator for rotating the gimbal about the first axis. In some embodiments, the gimbal includes a first through hole actuator for rotating the gimbal about the first axis and a second through hole actuator for rotating the gimbal about the second axis.

According to some embodiments, the system comprises a steering range, and the reflector assembly is sized such that the reflector assembly may reflect RF signals onto the focal point across the entire steering range.

According to some embodiments, the feed chain is configured to transmit and/or receive Q, V, Ka or Ku band signals.

According to some embodiments, the antenna system comprises a single offset antenna.

According to some embodiments, the antenna system comprises a folded single offset antenna.

According to some embodiments, the antenna system comprises an offset reflector antenna.

According to some embodiments, the reflector assembly comprises a parabolic reflector.

According to some embodiments, the reflector is enlarged in an offset direction.

According to some embodiments, the antenna system comprises a rotational axis at the base of the boom for folding the antenna system.

A method of steering an antenna system is also provided. The method includes actuating a gimbal coupling a reflector assembly of the antenna system to a feed chain of the antenna system about an axis aligned with a longitudinal axis of the feed chain, wherein when the gimbal is actuated, the feed chain remains at the focal point of the reflector assembly.

According to some embodiments, the gimbal comprises a bi-axis gimbal, and actuating the gimbal comprises rotating the gimbal about each axis.

According to some embodiments, the method further comprises receiving a steering signal and actuating the gimbal according to the steering signal.

According to some embodiments, the antenna system comprises a single offset antenna.

According to some embodiments, the antenna system comprises a folded single offset antenna.

According to some embodiments, the antenna system comprises an offset reflector antenna.

According to some embodiments, the reflector assembly comprises a parabolic reflector.

According to some embodiments, the focal point of the reflector is a unique point in space and is defined as a point where all rays coming from that point will end up parallel after being reflected on the reflector.

A method of transmitting or receiving RF signals is also provided. The method includes: reflecting a first RF signal with an antenna reflector to or from a radiating component while the antenna reflector is in a first position; steering the antenna reflector from a focal point of the reflector from the first position to a second position, such the focal point remains fixed in space as the antenna reflector is steered; and reflecting a second RF signal with the antenna reflector to or from the radiating component while the antenna reflector is in the second position.

In an embodiment, steering the antenna reflector is performed using a bi-axis gimbal including a through hole actuator configured to keep first and second axes of rotation of the bi-axis gimbal aligned with the focal point.

An antenna system is also provided. The antenna system includes: a radiating component for transmitting or receiving an RF signal; a reflector for reflecting the RF signal to or from the radiating component, the reflector having a focal point; and a gimbal configured to steer the reflector from the focal point of the reflector such that the focal point remains fixed in space as the reflector is steered.

In an embodiment, the gimbal is a two-axis gimbal comprising a through hole actuator configured to keep first and second rotational axes of the two-axis gimbal aligned with the focal point.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of an antenna system configured to enable antenna steering, according to an embodiment;

FIG. 2 is a detail perspective view of the gimbal and feed chain of the system of FIG. 1, according to an embodiment;

FIG. 3 shows a two-dimensional depiction of the variable active area of the reflector of the system of FIGS. 1 to 2, according to an embodiment;

FIG. 4 is a cross sectional side perspective view of the reflector of the system of FIGS. 1 to 3 along the offset axis, according to an embodiment;

FIG. 5 is a perspective view of an antenna system, according to another embodiment;

FIG. 6 is a flowchart of a method of antenna steering of the antenna systems of FIGS. 1-5, according to an embodiment; and

FIG. 7 is a perspective view of an antenna system comprising a flat reflector, according to another embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to antennas, and more particularly to systems, methods, and devices for antenna steering. While the antenna systems described herein are particularly configured for use in space environments, the systems may be applied to any antenna steering application.

Generally, the present disclosure provides a system for rotating a reflector of an antenna system to steer the antenna system in a manner whereby a location of a focal point of the reflector remains unchanged during rotation.

While the present disclosure makes reference throughout to a “feed chain”, it should be understood that the feed chain may be any radiating component and that a feed chain with a horn antenna is one example. A radiating component is a device providing radiation to illuminate the reflector. This may be any type of antenna (for example, without limitation, helix, patch antenna, horn antenna). A feed chain feeds the radiating component. The feed chain may be a waveguide feed chain or other technology (TEM line feed chains, PCB feed network, laser, etc.)

While typically reflectors are steered using a mechanism underneath the reflector or at its base, the present disclosure provides an antenna reflector steering mechanism including a gimbal positioned at the focal point (at the feed) and that steers the reflector from the focal point, rather than by using a mechanism near the reflector. By doing so, the steering system and method of the present disclosure keeps the focal point location unchanged. In an embodiment, the steering mechanism uses a through hole motor or actuator to keep the two axes aligned with the focal point of the reflector. In some embodiments, the steering mechanism may use a through hole actuator for each of the two axes of rotation.

In an embodiment, the antenna system of the present disclosure includes a parabolic reflector and a feed chain coupled through a gimbal which may alter the orientation of the reflector about the fixed feed chain. By altering the orientation of the reflector about the feed chain, the antenna may be steered such that RF signals emitted or received by the antenna system are emitted or received at or from different directions.

The gimbal of the antenna system described herein is positioned at the focal point of the reflector, such that the position of the reflector is rotated about the focal point of the reflector. The feed chain is positioned at a rotational center of the system, such that the system (e.g., the reflector) rotates about the feed chain, which is longitudinally aligned with this axis of rotation.

The reflector of the system may be enlarged about the offset axis or direction. Such enlargement may advantageously improve performance of the reflector. As the system is varied in position, one may conceptualize an active area of the reflector as a subset of a total reflector area.

The range of motion of the system is limited according to the physical specifications and operating RF parameters of the system. The reflector may be enlarged to enable antenna steering. A greater steering range may require a greater level of antenna enlargement along the offset axis of the reflector. The range of motion of the system is limited according to reflector size, and other parameters which may affect RF performance. This limited range of motion corresponds to a limited antenna steering range.

In an embodiment, about one axis which the reflector is rotated (e.g. the axis longitudinally aligned with the feed chain), there is no degradation of RF performance after steering the antenna system.

In embodiments, the antenna system and steering concept of the present disclosure may be used on a single offset or folded single offset antenna.

The reflector may be enlarged along the offset direction of the parabola to reduce the spillover when the antenna is steered around Azimuth.

Embodiments of the present disclosure may provide various advantages including, for example and without limitation, eliminating the need for rotary joints by using a fixed feed and no degradation (scan loss) on one axis with very limited scan loss on the other axis.

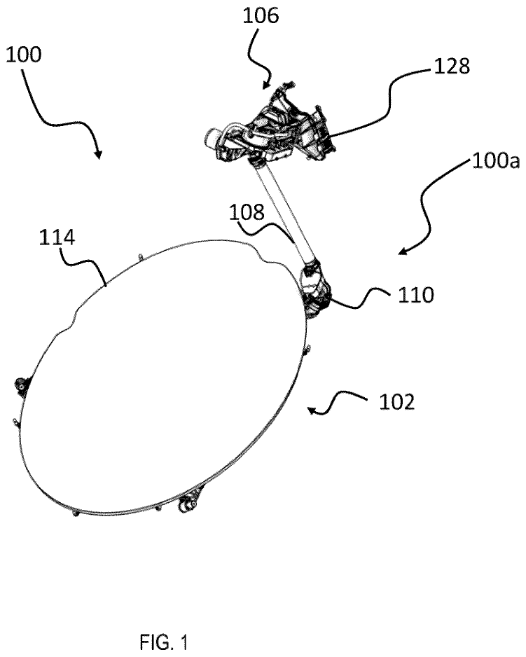

Referring now to FIG. 1, pictured therein is a perspective view of an antenna system 100, in a first configuration 100a, according to an embodiment.

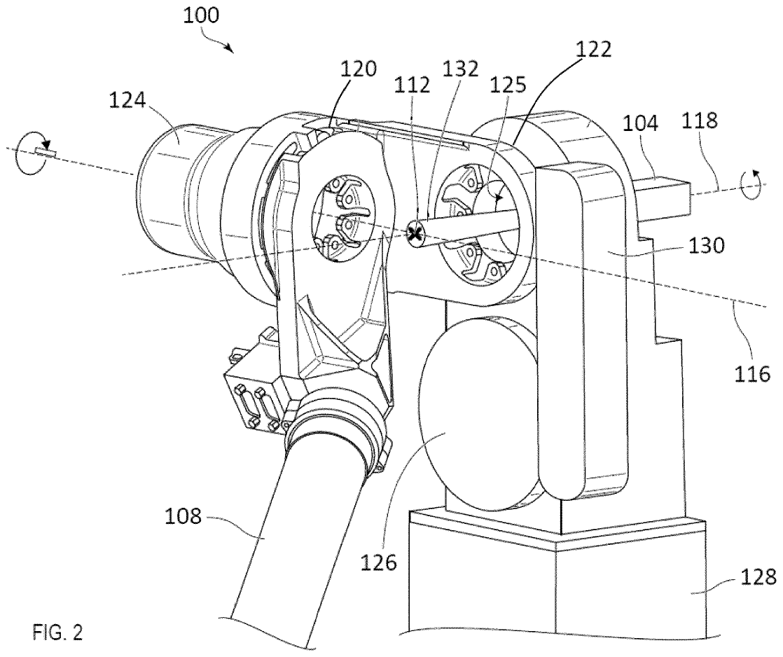

The antenna system 100 comprises a reflector assembly 102, feed chain 104 (visible in FIG. 2), gimbal 106, boom 108, stowing joint 110, and mounting structure 128. In other embodiments, the feed chain 104 may be a radiating component. The radiating component may be, for example, a helix, a patch antenna, or a horn antenna. The radiating component provides radiation to illuminate the reflector of the reflector assembly 102. The radiating component may be positioned similarly to feed chain 104 in FIG. 2.

As will be described, the gimbal 106 is positioned at the focal point of the reflector 102. The reflector 102 is steered from the focal point using the gimbal 106. In an embodiment (as shown in FIG. 2), the gimbal 106 includes a through hole motor or actuator to keep the two axes aligned with the focal point of the reflector 102.

While antenna system 100 comprises a parabolic antenna system with a single reflector 114, the systems and methods described herein may be applied to other antenna types or parabolic antenna configurations, such as Cassegrain, Dragonian and/or Gregorian antennas. The antenna system 100 may comprise a single offset or folded single offset antenna. The antenna system 100 may be used as a steerable antenna system on geosynchronous/geostationary (GEO) or non-geostationary satellite orbits.

Reflector assembly 102 comprises a large parabolic reflector 114. Reflector assembly 102 may be configured to receive or transmit RF signals. RF signals incident on reflector 114 may be reflected back, and focused, onto a focal point 112 (see FIG. 2).

In some examples, reflector 114 may be slightly shaped relative to a parabolic profile to improve performance.

Reflector 114 may be constructed from any appropriate material, for example, without limitation, aluminum, stainless steel, or titanium alloys, other metal alloys, composite materials such as carbon fiber reinforced polymers. Reflector 114 may be coated with a material to increase mechanical and/or RF performance. For example, the reflector 114 may comprise an aluminum substrate, coated with iridite (also referred to as chromate conversion coating or Alodine). In other examples, the reflector 114 may comprise a carbon fiber substrate, vacuum deposited with aluminum. In other examples, the reflector 114 may comprise metallized Kapton.

In some examples, reflector 114 may comprise a PCB or PCBs and/or dielectrics. In some examples, reflector 114 may comprise a PCB stack, on a Kevlar™ core. In some examples, reflector 114 may comprise a flat PCB surface, comprising additional elements which may allow the reflector 114 to act as a parabolic reflector 114.

In some examples, one or more components of the reflector assembly 102 may be configured to be additively manufactured. For example, in an embodiment, reflector 114 may be additively manufactured.

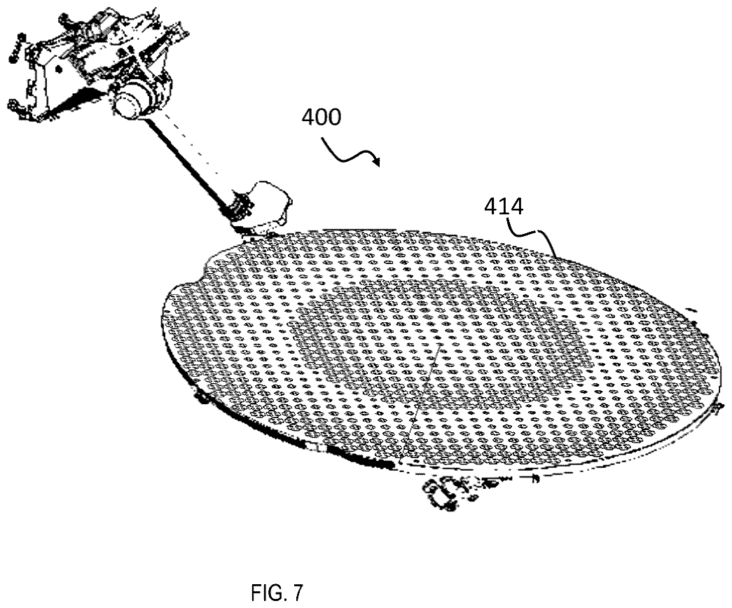

In some examples, the reflector 114 may be a flat reflector variant. For example, see reflector 414 of system 400 of FIG. 7, wherein reflector 414 is a flat reflector.

Reflector assembly 102 comprises a focal point 112 (as pictured in FIG. 2). As system 100 is varied in configuration (e.g., between any number of other possible configurations within the range of motion of gimbal 106 and design of system 100, to move the position of the reflector 114), the focal point 112 remains at the same position relative to reflector 114. Focal point 112 is a function of the shape, design and/or configuration of reflector 114. The focal point 112 of the reflector is a unique point in space and may be defined as the point where all rays coming from that point will end up parallel after being reflected on the paraboloid reflector.

In some examples, reflector 114 may comprise a dual gridded reflector (on a sub reflector, not pictured herein) or may comprise a frequency selective surface. In some examples, reflector 114 may comprise a frequency selective surface on a sub-reflector (not pictured).

Feed chain 104 comprises a subsystem of electromechanical components configured to emit or receive RF signals. Feed chain 104 may be configured to receive a specific band or frequency range of RF signals (e.g., Ka band), or may be configured to receive or transmit multiple bands of RF signals (e.g., Ka, Q and V band). In some embodiments, feed chain 104 may be configured to transmit or receive any number of RF bands. In some embodiments, feed chain 104 may be configured to both transmit and receive RF signals.

In variations, feed chain 104 may be configured to transmit and/or receive Q, V, Ka, Ku, X, C, S, L, UHF, E, W, F, and/or D bands.

Referring now to FIG. 2, feed chain 104 is positioned such that a horn 132 (or other radiating component) of the feed chain 104 is positioned at or very near the focal point 112 of the reflector 114. Feed chain 104 is longitudinally aligned with first axis 118, such that the center of feed chain 104 along the longest axis of feed chain 104 is intersecting axis 118 about which system 100 may be steered. First axis 118 may be referred to as the longitudinal axis of feed chain 104.

Gimbal 106 generally comprises a rotational joint or joints coupling feed chain 104 to reflector assembly 102. In FIG. 2, gimbal 106 is shown in greater detail, according to an embodiment. Gimbal 106 comprises a bi-axial gimbal, having two rotational degrees of freedom, about the first linear axis 118 and a second linear axis 116. Axes 116 and 118 are orthogonal to one another. In other embodiments, axes 116, 118 may not be orthogonal to one another. In other examples, more rotational degrees of freedom may be present, and axes may or may not be orthogonal to one another.

Gimbal 106 is positioned generally at or near focal point 112 of reflector 114, such that throughout the range of motion of gimbal 106, gimbal 106 is generally positioned at a focal point 112 of reflector 114. Specifically, the intersection of axis 116 and axis 118 is aligned with focal point 112 across the range of motion of gimbal 106.

Axis 116 is aligned with rotational joint 120 and axis 118 is aligned with rotational joint 122. Each rotational joint 120, 122 may be varied in position to alter the relative positions of reflector 114 and feed chain 104. Each rotational joint 120, 122 comprises an integrated potentiometer (not visible), to measure joint 120, 122 position. Joint 120, 122 position recorded by this potentiometer may be provided to a computer system or control system associated with system 100 to provide for closed loop control of the position of rotational joint 120, 122. In other examples, system 100 may apply open loop control schemes. In some examples, each rotational joint 120, 122 may comprise additional mechanical components, such as mounting structures, rotational bearings, and other components, according to each specific configuration and application and service requirements.

In the example of system 100, joint 122 includes a through hole rotational actuator 126. The rotational actuator 124 is configured to actuate joint 120. Through hole in joint 122 is denoted by reference numeral 125. In other embodiments, the rotational actuator 124 for actuating joint 120 may be a through hole actuator (e.g., like actuator 126).

Joint 122 is actuated indirectly by actuator 126, through bar linkage or connecting rod 130. As feed chain 104 is aligned with rotational axis 118, direct actuation would mechanically interfere with the positioning of feed chain 104 in alignment with rotational axis 118.

Joint 120 is actuated directly by actuator 124 (e.g., without use of a through hole). There is no issue with feed chain 104 mechanical interference, as the feed chain is not positioned along axis 116. This arrangement advantageously allows the system 100 to be steered about axis 118, allowing for steering with no degradation of RF performance when steering about axis 118. In some examples, this axis may be referred to as the “Z axis”.

Actuators 124, 126 may be computer controlled by a computer system or control system associated with system 100 to precisely vary the relative position of each joint 120, 122. Such position variation may be controlled in a closed loop manner, using position feedback provided by potentiometers as previously described, or using an open loop control scheme. In other examples, other sensors may provide position data of each joint 120, 122 to provide for closed loop control.

The range of motion of joins 120, 122 may be limited to correspond with the steering range of system 100. For example, each joint may be limited to a range of motion of 40 degrees. In other examples, other range of motion limits may be applied to each joint 120, 122, according to the configuration of the other components of system 100.

Referring again to FIG. 1, boom 108 comprises a structural component, coupling gimbal 106 to reflector assembly 102. Where the joints 120, 122 include the first and second brackets, boom 108 may be connected to the second bracket (of joint 120). Boom 108 has a generally cylindrical shape, however in other examples, the shape and size of boom 108 may vary. Boom 108 may be constructed from any mechanically suitable material which provides for appropriate stiffness and weight, for example, without limitation, aluminum, stainless steel, or titanium alloys, other metal alloys, composite materials such as carbon fiber reinforced polymers.

In some embodiments, system 100 may further comprise a stowing joint 110. The stowing joint is positioned between reflector assembly 102 and boom 108 and couples reflector assembly 102 to boom 108. Stowing joint 110 provides a one degree of freedom rotational axis, such that antenna system 100 may be moved into a more compact arrangement to reduce the total space or volume occupied by system 100. Such a volume reduction achieved through the actuation of stowing joint 110 may be particularly advantageous when system 100 is applied in space applications, wherein system 100 may be launched into orbit on a launch vehicle such as a rocket. Payload volume may be limited on this launch vehicle. Reducing the volume of system 100 during launch may reduce launch and deployment costs of system 100 in space applications.

In other examples, stowing joint 110 may comprise more degrees of freedom, or other mechanisms of motion. In some examples, stowing joint 110 may comprise multiple subcomponents, and/or integrated actuators, such as stepper motors or other suitable actuators. In some examples, stowing joint 110 may be controlled by a computer system or control system associated with system 100, and may apply open loop or closed loop control schemes. In some examples, multiple stowing joints 110 may be present along boom 108, allowing for greater system compactness in a folded or stowed configuration.

System 100 further comprises mounting structure 128. Mounting structure 128 comprises a mechanical component fixed to rotational joint 122. Mounting structure 128 may be coupled to another system device or structure, stationary or otherwise, for example, a spacecraft such as a satellite, or a building. Mounting structure 128 may vary in configuration depending on the object system 100 is being mounted to. Mounting structure 128 of system 100 is configured to be mounted on an orbiting satellite.

In operation, system 100 may begin in a first position, wherein reflector assembly 102 is pointed in a certain direction, and reflector assembly 102 and feed chain 104 are in a certain relative orientation. For example, system 100 may be in position 100a as pictured in FIG. 1. In position 100a, reflector assembly 102 and feed chain 104 are in a certain relative orientation, and the horn 132 of feed chain 104 is aligned with a focal point of reflector assembly 102. In configuration 100a, system 100 may receive or transmit a signal from or to a specific direction. It may be desirable to steer the antenna of system 100, such that the antenna is oriented at a different direction, and system 100 may transmit or receive RF signals to or from different locations. For example, system 100 may be moved to a different configuration. Joints 120, 122 are varied in position using actuators 124, 126. This position variation for steering may be assisted by a computer system or control system associated with system 100.

Once system 100 has been placed into a second configuration, by altering the position of reflector 114 relative to feed chain 104 using gimbal 106, system 100 may transmit or receive RF signals to or from a different direction. As the feed chain 104 is positioned at focal point 112 of system 100 at all times, the antenna steering mechanism of system 100 is highly reliable, and simple, as fewer moving components are required, and fewer alignment issues may arise. There is no performance degradation when steering about axis 118, and very little degradation when steering about axis 116 (the offset axis). Additionally, the arrangement of system 100 allows for a relatively small dynamic volume, which is advantageous particularly for space deployed systems wherein volume limits or requirements may apply.

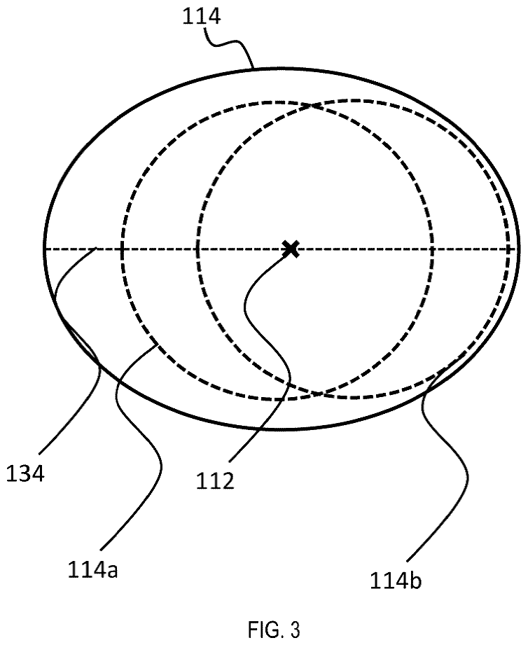

Referring now to FIG. 3, pictured therein is a two-dimensional depiction of reflector 114, according to an embodiment. Reflector 114 is associated with a singular focal point 112. The feed chain 104 is positioned at this singular focal point 112.

As described previously, system 100 may utilize an enlarged reflector 114, wherein the reflector 114 is enlarged along the offset axis direction, which is depicted as direction 134 in FIG. 3. This configuration of system 100 allows for antenna steering with reduced complexity, as feed chain 104 constantly remains at focal point 112 of the system 100. Accordingly, fewer alignment issues are possible, and less complicated electromechanical steering mechanisms are required for the steering of the antenna of system 100 as fewer components of system 100 are moving and feed chain 104 is fixed in this desirable position.

As system 100 is steered about axis 118, the system 100 may use a constant active area (e.g. active area 114a) of reflector 114. As system 100 is steered about axis 116, the active area of the reflector 114 may shift, along the offset direction 134, e.g. to active area 114b.

The steering range of system 100 is unlimited about axis 118 and limited only by physical interference constraints of the configuration of system 100 and its deployment. Steering range about axis 116 may be further limited by reflector enlargement, which may be particularly limited by mechanical constraints of the application of system 100 (e.g. launch spacecraft volume requirements). In some embodiments, the steering range about each axis may comprise 20 rotational degrees in each direction (for a total range of 40 degrees). In other embodiments, other steering ranges may be available.

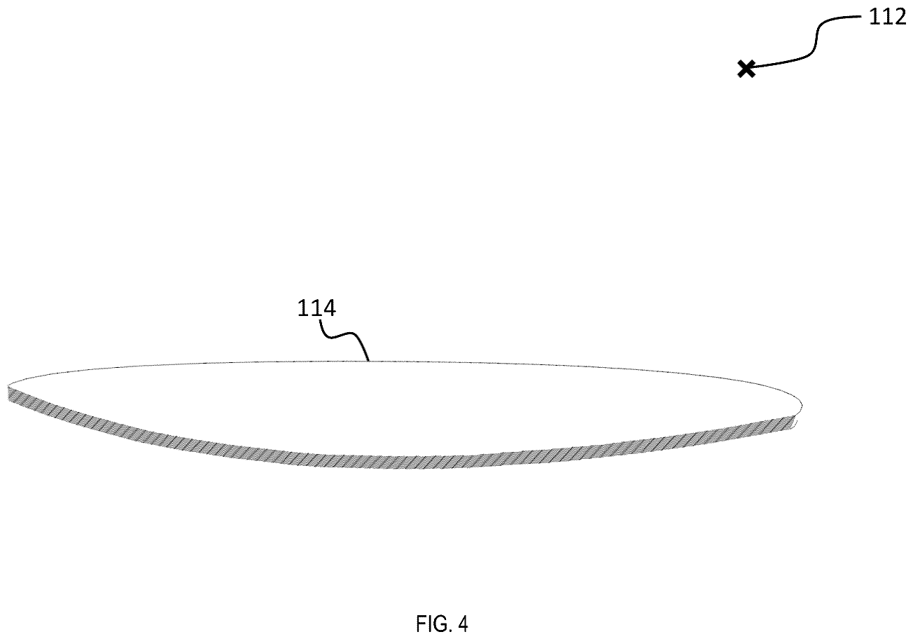

Referring now to FIG. 4, pictured therein is a cross sectional depiction of reflector 114 along axis 134, showing the parabolic cross section of reflector 114, according to an embodiment. The shape of reflector 114 corresponds to a focal point 112. As the reflector 114 is varied in position across the steering range of system 100, the focal point 112 of the system will be at a constant position. Accordingly, the feed chain 104 will be in alignment with the focal point 112.

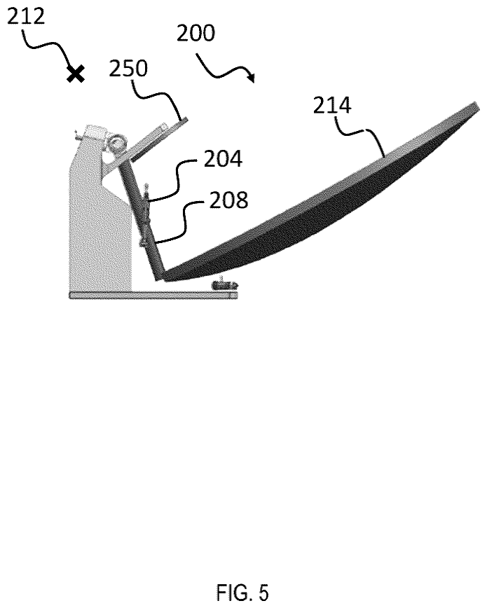

Referring now to FIG. 5, shown therein is an antenna system 200 comprising a steering mechanism, according to an embodiment. System 200 comprises a folded optic variant of system 100. Components of system 200 are analogous to system 100, with reference characters incremented by 100. System 200 includes focal point 212, reflector 214, boom 208, and feed chain 204.

System 200 differs from system 100 in that system 200 comprises a secondary reflector 250. Secondary reflector 250 is positioned such that when system 200 is steered, RF signals are directed on secondary reflector 250, and then are directed and focused onto a feed chain 204.

The focal point 212 of the primary reflector of system 200 is behind or past the secondary reflector 204, such that the path length of radiation after reflection by the primary reflector corresponds to the distance of the focal point from the primary reflector. Such an arrangement reduces the necessity of through hole actuators to steer system 200, and feed chain of system 200 may be positioned closer to a spacecraft to which system 200 is attached, limiting waveguide lengths, and accordingly, signal and/or performance losses. Otherwise, the operation of system 200 is analogous to the operation of system 100. Second reflector 250 is placed between the focal point 212 and the reflector 214 so that a virtual focal point is created at a mirrored place with respect to the second reflector 250. In such an embodiment, a through hole may not be used (i.e., no through hole actuator), as there is no need for a through hole. Further, in this embodiment, the feed chain 204 interface can be positioned closer to the spacecraft, which can advantageously limit the length of waveguides in the feed chain (less losses).

In other examples, other variations of the systems described herein may be applied.

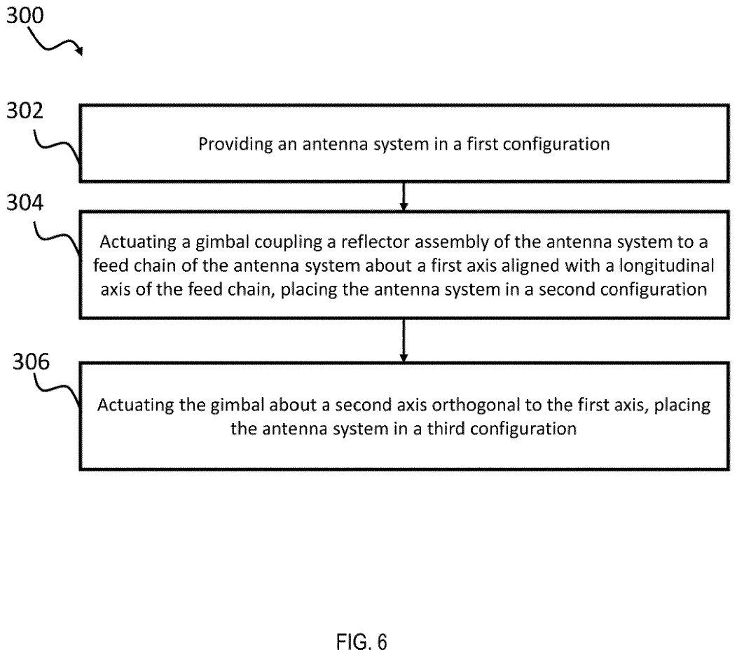

Referring now to FIG. 6, pictured therein is a flow chart depicting a method 300 of operating device 100 of FIGS. 1 to 5, according to an embodiment. Method 300 comprises steps 302 and 304.

At 302, an antenna system is provided in a first configuration.

At 304, a gimbal coupling a reflector assembly of the antenna system to a feed chain of the antenna system is actuated about a first axis aligned with a longitudinal axis of the feed chain, placing the antenna system in a second configuration. The location of the focal point of the reflector remains fixed or unchanged in space during the actuation about the first axis.

At 306, the gimbal is actuated about a second axis orthogonal to the first axis, placing the antenna system in a third configuration. In other embodiments, the second axis may be at a non-orthogonal angle to the first axis. The location of the focal point of the reflector remains fixed or unchanged in space during the actuation about the second axis.

While the above description provides examples of one or more apparatus, methods, or systems, it will be appreciated that other apparatus, methods, or systems may be within the scope of the claims as interpreted by one of skill in the art.

1. An antenna system, the system comprising:
a radiating component for transmitting and/or receiving a radio frequency signal, the radiating component longitudinally aligned along a first axis; and
a reflector assembly coupled to the radiating component through a gimbal;
wherein the gimbal is configured to rotate the reflector assembly about the first axis to steer the antenna system, such that when the reflector assembly is rotated, a focal point of the reflector in space remains unchanged.

2. The system of claim 1, wherein the gimbal comprises a bi-axis gimbal, and the bi-axis gimbal is configured to rotate the reflector assembly about the first axis and a second axis, such that when the reflector assembly is rotated, the focal point of the reflector in space remains unchanged.

3. The system of claim 2, wherein the two axes are orthogonal.

4. The system of claim 1, wherein the reflector assembly is coupled to the gimbal through a boom.

5. The system of claim 2, wherein the gimbal comprises a through-hole actuator for rotating the gimbal about the first axis.

6. The system of claim 1, wherein the system comprises a steering range, and the reflector assembly is sized such that the reflector assembly reflects RF signals onto the focal point across the entire steering range.

7. The system of claim 1, wherein the antenna system comprises a single offset antenna, a folded single offset antenna, or an offset reflector antenna.

8. The system of claim 1, wherein the reflector assembly comprises a parabolic reflector.

9. The system of claim 1, wherein the reflector is enlarged in an offset direction.

10. The system of claim 4, wherein the antenna system comprises a rotational axis at the base of the boom for folding the antenna system.

11. A method of steering an antenna system, the method comprising:
actuating a gimbal coupling a reflector assembly of the antenna system to a radiating component of the antenna system about an axis aligned with a longitudinal axis of the radiating component;
wherein when the gimbal is actuated, the location of a focal point of the reflector in space remains unchanged.

12. The method of claim 11, wherein the gimbal comprises a bi-axis gimbal, and actuating the gimbal comprises rotating the gimbal about each axis.

13. (canceled)

14. The method of claim 11, wherein the antenna system comprises a single offset antenna, a folded offset single antenna, or an offset reflector antenna.

15. The method of claim 11, wherein the reflector assembly comprises a parabolic reflector.

16. The system of claim 1, wherein the radiating component is a horn antenna fed by a feed chain.

17. The method of claim 11, wherein the radiating component is a horn antenna fed by a feed chain.

18. A method of transmitting or receiving RF signals, the method comprising:
reflecting a first RF signal with an antenna reflector to or from a radiating component while the antenna reflector is in a first position;
steering the antenna reflector from a focal point of the reflector from the first position to a second position, such the focal point remains fixed in space as the antenna reflector is steered; and
reflecting a second RF signal with the antenna reflector to or from the radiating component while the antenna reflector is in the second position.

19. The method of claim 18, wherein steering the antenna reflector is performed using a bi-axis gimbal including a through hole actuator configured to keep first and second axes of rotation of the bi-axis gimbal aligned with the focal point.

20. An antenna system comprising:
a radiating component for transmitting or receiving an RF signal;
a reflector for reflecting the RF signal to or from the radiating component, the reflector having a focal point; and
a gimbal configured to steer the reflector from the focal point of the reflector such that the focal point remains fixed in space as the reflector is steered.

21. The system of claim 20, wherein the gimbal is a two-axis gimbal comprising a through hole actuator configured to keep first and second rotational axes of the two-axis gimbal aligned with the focal point.
